(19) United States
(12) Patent Application Publication
(10) Pub. No.: US 2026/0316646 A1
(43) Pub. Date: Oct. 15, 2026

(54) TRANSPORTATION VEHICLE SEAT MEMBER AND TRANSPORTATION VEHICLE SEAT

(71) Applicant: NHK SPRING CO., LTD., Yokohama-shi (JP)

(72) Inventors: Masakazu ANDO, Yokohama-shi (JP); Tsukasa KOMOGUCHI, Yokohama-shi (JP); Daisuke TANAKA, Yokohama-shi (JP); Koichi KAWASAKI, Yokohama-shi (JP)

(21) Appl. No.: 19/639,631

(22) Filed: Apr. 6, 2026

(30) Foreign Application Priority Data
Apr. 9, 2025 (JP) 2025-064550

(51) Int. Cl. B60N 2/68

(52) U.S. Cl. CPC B60N 2/682

(57) ABSTRACT

A transportation vehicle seat member configuring part of a transportation vehicle seat, and including a front member, a back member, a coupling member configured to couple the front member and the back member together and configured such that the coupling is released by applying an external force in a separation direction to separate the front member from the back member, and a separation restriction section that is configured by an engaging portion provided to one out of the front member or the back member and an engaged portion provided to another of the front member or the back member, that is configured to restrict separation by engagement of the engaging portion and the engaged portion in the separation direction, and that is configured to release the restriction by the front member being displaced with respect to the back member in a direction intersecting with the separation direction.

### CROSS-REFERENCE TO RELATED APPLICATION

This application is based on and claims priority under 35 USC 119 from Japanese Patent Application No. 2025-064550 filed on Apr. 9, 2025, the disclosure of which is incorporated by reference herein.

### BACKGROUND

### Technical Field

The present disclosure relates to a transportation vehicle seat.

### Related Art

In a chair disclosed in Japanese Patent Application Laid-Open (JP-A) No. H9-285360, a frame support section supported by a back support rod configured from metal pipes or the like protrudes into a back member of a backrest, and the backrest is fixed to the back support rod by a front member and the back member of the backrest being fastened together by inserting bolts through bolt insertion portions provided to the back member.

### SUMMARY

A task to separate the front member and the back member is complicated in the above related art due to the poor operability of a task to loosen bolt-fastening of the front member and back member of the backrest. In particular, in transportation vehicle seats, because there are cases in which space for loosening bolts with a tool is unable to be secured at the back side of the backrest, there is room for improvement from the perspective of facilitating a task to separate the front member and the back member.

An object of the present disclosure is to obtain a transportation vehicle seat member and a transportation vehicle seat that are capable of facilitating a task to separate the front member and the back member.

A transportation vehicle seat member of a first aspect of the present disclosure configures part of a transportation vehicle seat. The transportation vehicle seat member includes a front member configured to contact a seated person, a back member arranged at an opposite side of the front member to the seated person, a coupling member configured to couple the front member and the back member together and configured such that coupling is released by applying an external force in a separation direction to separate the front member from the back member, and a separation restriction section that is configured by an engaging portion provided to one out of the front member or the back member and an engaged portion provided to another of the front member or the back member, that is configured to restrict the separation by engagement of the engaging portion and the engaged portion in the separation direction, and that is configured to release the restriction by the front member being displaced with respect to the back member in a direction intersecting with the separation direction.

In the transportation vehicle seat member of the first aspect, the front member that contacts the seated person, and the back member arranged at the opposite side of the front member to the seated person, are coupled together by the coupling member. The engaging portion of the separation restriction section is provided to one out of the front member or the back member and the engaged portion of the separation restriction section is provided to another of the front member or the back member. Separation of the front member from the back member is restricted by, in the separation restriction section, the engaging portion and the engaged portion engaging in the separation direction of the front member from the back member. When separating the front member from the back member, coupling of the coupling member can be released by, for example, inserting a tool such as a spatula or the like between the front member and the back member, and applying an external force in the separation direction described above. After this has been performed, the restriction by the separation restriction section can then be released by the front member being displaced with respect to the back member in a direction intersecting with the separation direction. This thereby enables a task of separating the front member and the back member to be facilitated compared to hitherto.

A transportation vehicle seat member of a second aspect is the first aspect, wherein the engaging portion is formed in a hook shape, and the engaged portion includes an insertion hole for insertion of the engaging portion.

In the transportation vehicle seat member of the second aspect, the engaging portion formed in a hook shape and provided to one out of the front member or the back member is inserted into the insertion hole of the engaged portion provided to another of the front member or the back member. This thereby enables separation of the front member and the back member to be restricted by a simple configuration.

A transportation vehicle seat member of a third aspect is the second aspect, further including a first separation restriction section, arranged at one side in an orthogonal direction orthogonal to the separation direction, and a second separation restriction section arranged at the another side in the orthogonal direction.

The transportation vehicle seat member of the third aspect includes the first and second separation restriction sections arranged on opposite sides to each other in an orthogonal direction orthogonal to the separation direction of the front member from the back member, thereby enabling separation of the front member from the back member to be effectively restricted.

The transportation vehicle seat member of the fourth aspect is the third aspect, wherein a displacement direction of the front member for releasing the restriction by the first separation restriction section is toward the another side in the orthogonal direction, and a displacement direction of the front member for releasing the restriction by the second separation restriction section is toward the one side in the orthogonal direction.

In the transportation vehicle seat member of the fourth aspect, the displacement direction of the front member for releasing the restriction on separation of the front member from the back member by the first separation restriction section is set so as to be in the opposite direction to the displacement direction of the front member for releasing the restriction on separation of the front member from the back member by the second separation restriction section, thereby making the restriction on separation of the front member from the back member not liable to being released unintentionally.

A transportation vehicle seat member of a fifth aspect is any one aspect of the first aspect to the fourth aspect, wherein the front member includes a front-side pan frame formed in a plate shape, a pad superimposed on a surface of the front-side pan frame, and a front-side covering that covers the pad from an opposite side to the front-side pan frame and that has an outer edge portion anchored to the front-side pan frame.

In the transportation vehicle seat member of the fifth aspect, the front member is configured as described above, thereby enabling the front member to be a simple configuration and also enabling the comfort of the seated person to be secured by the pad.

A transportation vehicle seat member of a sixth aspect is any one aspect of the first aspect to the fifth aspect, wherein the back member includes a back-side pan frame formed in a plate shape, and a back-side covering that covers a surface of the back-side pan frame and has an outer edge portion anchored to the back-side pan frame.

In the transportation vehicle seat member of the sixth aspect, the back member is configured as described above, thereby enabling the back member to be a simple configuration and also enabling a good external appearance of the back member to be achieved by the back-side covering.

A transportation vehicle seat of a seventh aspect includes a seat cushion configured to support the buttocks and thighs of a seated person, a seatback configured to support a back of the seated person, and a headrest configured to support a head of the seated person, wherein at least one of the seat cushion, the seatback or the headrest comprises the transportation vehicle seat member of any one aspect of the first aspect to the sixth aspect.

In the transportation vehicle seat of a seventh aspect, at least one of the seat cushion, the seatback, or the headrest is the transportation vehicle seat member of any one aspect of the first aspect to the sixth aspect, and so the above listed advantageous effects are exhibited.

As described above, the transportation vehicle seat member and the transportation vehicle seat according to the present disclosure are able to make facilitate a task to separate the front member and the back member.

### BRIEF DESCRIPTION OF THE DRAWINGS

Exemplary embodiments of the present invention will be described in detail based on the following figures, wherein:

FIG. 1 is a side view illustrating a transportation vehicle seat according to an exemplary embodiment;

FIG. 2 is a cross-section illustrating a section taken along line F2-F2 of FIG. 1;

FIG. 3 is a perspective view illustrating a back member of a seatback of a transportation vehicle seat according to an exemplary embodiment, as viewed from a front face side;

FIG. 4 is a perspective view of a front member of a seatback of a transportation vehicle seat according to an exemplary embodiment, as viewed from a back face side;

FIG. 5 is a first explanatory diagram to explain an attachment method of a front member to a back member of a seatback;

FIG. 6 is a second explanatory diagram to explain an attachment method of a front member to a back member of a seatback; and

FIG. 7 is a third explanatory diagram to explain an attachment method of a front member to a back member of a seatback.

### DETAILED DESCRIPTION

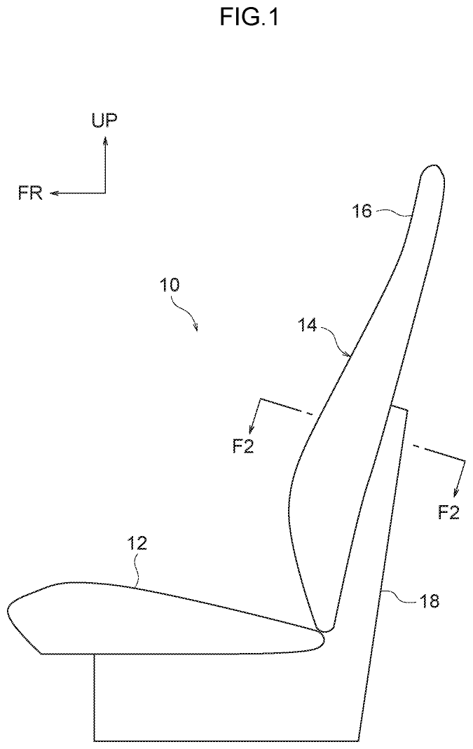

Description follows regarding a transportation vehicle seat 10 according to a first exemplary embodiment of the present disclosure, with reference to FIG. 1 to FIG. 7. Note that sometimes some of the reference numerals are omitted in the drawings in order to facilitate readability of the drawings. Moreover, arrows FR, LH, and UP in the drawings respectively indicate, as appropriate, forward, rightward, and upward for the transportation vehicle seat 10. When the following description simply refers to front and rear, left and right, and up and down directions, these indicates directions with respect to the transportation vehicle seat 10.

As illustrated in FIG. 1, the transportation vehicle seat 10 according to the present exemplary embodiment includes a seat cushion 12 for supporting the buttocks and thighs of a non-illustrated seated person, and a seatback 14 for supporting the back of the seated person. The seatback 14 is configured as an integral-headrest type of seatback in which a headrest 16 for supporting the head of the seated person is provided to a single body. The seat cushion 12 and the seatback 14 are attached to a floor section (omitted in the drawings) of a transportation vehicle through a frame 18. The seatback 14 corresponds to a “transportation vehicle seat member” of the present disclosure. Note that the seatback 14 and the headrest 16 may be configured as separate bodies.

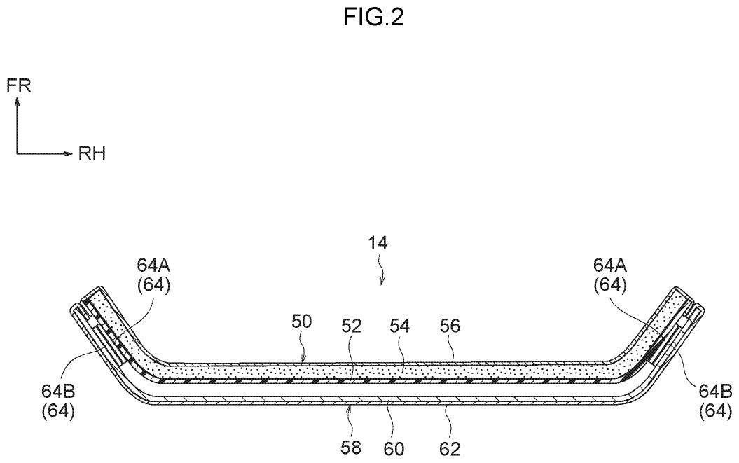

As illustrated in FIG. 2, the seatback 14 includes a front member 50 to contact the back of the seated person, a back member 58 arranged at the opposite side of the front member 50 to the seated person side (the rear side in this case), plural hook-and-loop fasteners 64 serving as coupling members separably-coupling the front member 50 and the back member 58, and a first separation restriction section 66 and a second separation restriction section 72 for restricting the front member 50 and the back member 58 from separation.

The front member 50 is configured from a front-side pan frame 52, a pad 54, and a front-side covering 56. The front-side pan frame 52 is, for example, formed in a substantially rectangular plate shape from a resin, and is arranged with a length direction substantially along the height direction and with a plate thickness direction substantially along the front-rear direction. Left and right side portions of the front-side pan frame 52 are bent diagonally toward the front side. The pad 54 is, for example, formed in a substantially rectangular plate shape from a foam body, such as a urethane foam or the like, and is superimposed on a front face (surface) of the front-side pan frame 52. The front-side covering 56 is, for example, configured from a cloth material, leather, synthetic leather, or the like, and covers the pad 54 from the front side (namely, the opposite side to the front-side pan frame 52). An outer edge portion of the front-side covering 56 is folded back to the rear face side (back-face side) of the front-side pan frame 52, and is anchored to the front-side pan frame 52 by a means such as an adhesive or the like.

The back member 58 is configured from a back-side pan frame 60 and a back-side covering 62, and is fixed to the frame 18 as described above. The back-side pan frame 60 is, for example, formed in a substantially rectangular plate shape from a resin, and is arranged with a length direction substantially along the height direction and with a plate thickness direction substantially along the front-rear direction. Left and right side portions of the back-side pan frame 60 are bent diagonally toward the front side. The back-side covering 62 is, for example, configured from a cloth material, leather, synthetic leather, or the like and covers the rear face (surface) of the back-side pan frame 60. An outer edge portion of the back-side covering 62 is folded back to the side of the front face (back-face side) of the back-side pan frame 60, and is anchored to the back-side pan frame 60 by a means such as an adhesive or the like.

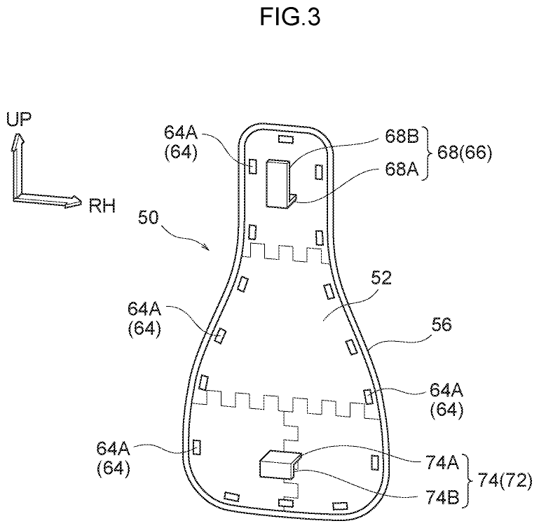

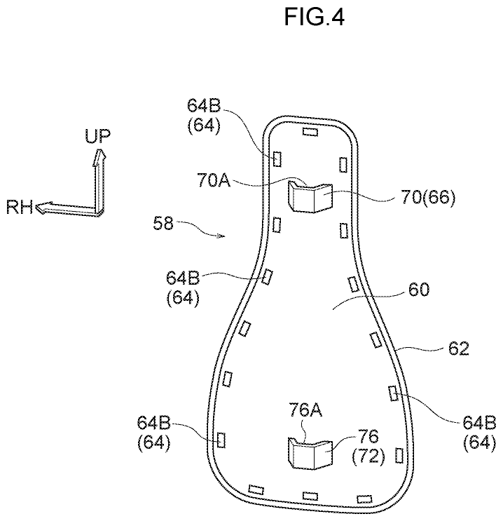

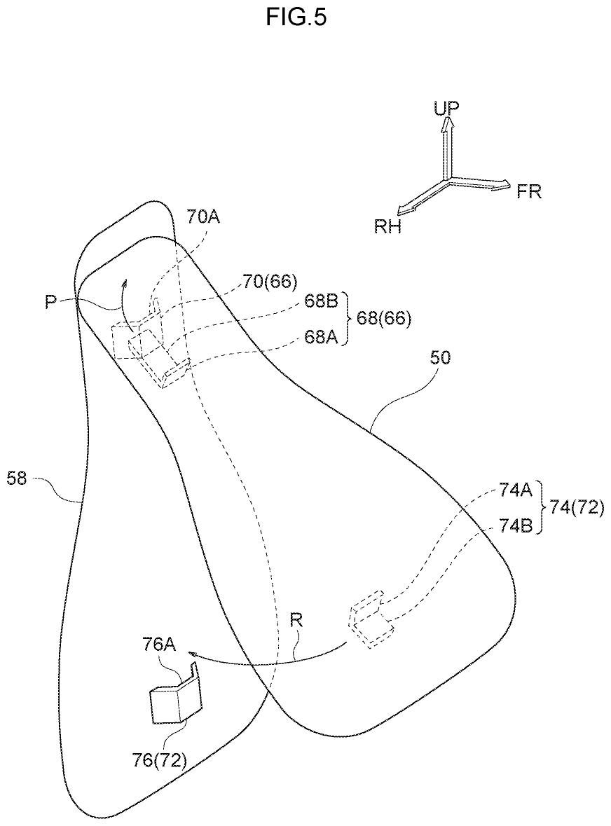

As illustrated in FIG. 3 and FIG. 4, plural hook-and-loop fasteners 64 are arranged in a row spaced out along an outer edge portion of the seat cushion 12. Each of the hook-and-loop fasteners 64 is, as an example, configured from hooks 64A stuck to a lower face of the outer edge portion of the front-side pan frame 52, and loops 64B stuck to an upper face of the outer edge portion of the back-side pan frame 60. The front member 50 and the back member 58 are coupled together by attaching the hooks 64A and the loops 64B of the respective hook-and-loop fasteners 64 together. Each of the hook-and-loop fasteners 64 is configured such that the above coupling is released by applying external force in a separation direction (in this case the front-rear direction) to separate the front member 50 and the back member 58. Note that illustration of the plural hook-and-loop fasteners 64 is omitted in FIG. 5 to FIG. 7.

The first separation restriction section 66 is arranged at an upper section of the seatback 14 (namely, at a one-side in an orthogonal direction of the seatback 14 orthogonal to the above separation direction), and is configured from a first engaging portion 68 provided to the front member 50 and a first engaged portion 70 provided to the back member 58. The second separation restriction section 72 is arranged at a lower section of the seatback 14 (namely, at an other-side in the orthogonal direction of the seatback 14 orthogonal to the separation direction), and is configured from a second engaging portion 74 provided to the front member 50 and a second engaged portion 76 provided to the back member 58.

The first engaging portion 68 and the second engaging portion 74 are, as an example, formed in hook shapes that each extend as a single body from a rear face of the front-side pan frame 52. The first engaging portion 68 is formed in an L-shape as viewed along the right-to-left direction, configured from a rear extension portion 68A extending rearward from a rear face of the front-side pan frame 52, and an upper extension portion 68B extending upward from a rear end of the rear extension portion 68A. The second engaging portion 74 is formed in an inverted L-shape as viewed along the right-to-left direction, configured from a rear extension portion 74A extending rearward from a rear face of the front-side pan frame 52, and a lower extension portion 74B extending downward from a rear end of the rear extension portion 74A.

The first engaged portion 70 and the second engaged portion 76, as an example, are formed in a substantially U-shape that each extend as a single body from a front face of the back-side pan frame 60, with a rear side thereof open when viewed along the height direction. Insertion holes 70A, 76A piercing through in the height direction are respectively formed in the first engaged portion 70 and the second engaged portion 76. The upper extension portion 68B of the first engaging portion 68 is inserted through the insertion hole 70A of the first engaged portion 70 from the lower side, and the lower extension portion 74B of the second engaging portion 74 is inserted through the insertion hole 76A of the second engaged portion 76 from the upper side.

In the first separation restriction section 66, the front member 50 and the back member 58 are restricted from separation in the front-rear direction by engagement of the upper extension portion 68B of the first engaging portion 68 and the first engaged portion 70 in the front-rear direction (namely, the separation direction). In the second separation restriction section 72, the front member 50 and the back member 58 are restricted from separation in the front-rear direction by engagement of the lower extension portion 74B of the second engaging portion 74 and the second engaged portion 76 in the front-rear direction.

Moreover, in the first separation restriction section 66, the engagement in the front-rear direction of the upper extension portion 68B of the first engaging portion 68 and the first engaged portion 70 (namely, restriction of the front member 50 and the back member 58 from separation) is released by the front member 50 being displaced downward (namely, toward the another side in the orthogonal direction) with respect to the back member 58. In the second separation restriction section 72, the engagement in the front-rear direction of the lower extension portion 74B of the second engaging portion 74 with the second engaged portion 76 (namely, restriction of the front member 50 and back member 58 from separation) is released by the front member 50 being displaced upward (namely, to the one side in the orthogonal direction) with respect to the back member 58.

The length along the height direction of the upper extension portion 68B of the first engaging portion 68 (namely, the portion inserted into the insertion hole 70A of the first engaged portion 70) is set longer than the length along the height direction of the lower extension portion 74B of the second engaging portion 74 (namely, the portion inserted into the insertion hole 76A of the second engaged portion 76).

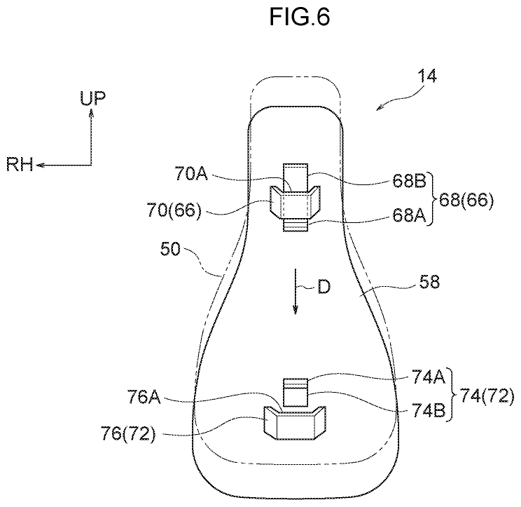

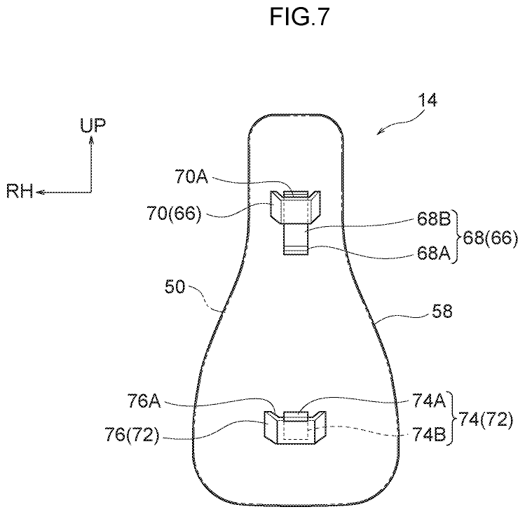

In the seatback 14 of the above configuration, when the front member 50 is attached to the back member 58, firstly, as indicated by arrow P of FIG. 5, the upper extension portion 68B of the first engaging portion 68 is inserted into the insertion hole 70A of the first engaged portion 70 from the lower side. Next, as indicated by arrow R of FIG. 5, the front member 50 is rotated to the back member 58 side such that the second engaging portion 74 is arranged above the second engaged portion 76. Next, as indicated by arrow D of FIG. 6, the front member 50 is displaced downward with respect to the back member 58, and the lower extension portion 74B of the second engaging portion 74 is inserted into the insertion hole 76A of the second engaged portion 76 from the upper side (see FIG. 7). After this, the hooks 64A and the loops 64B of the plural hook-and-loop fasteners 64 are attached. This accordingly completes attachment of the front member 50 to the back member 58. Note that the front member 50 and the back member 58 are schematically illustrated in FIG. 5 to FIG. 7. Moreover, although omitted in the drawings, when removing the front member 50 from the back member 58, the reverse sequence to the attachment sequence described above is employed.

Next, description follows regarding the operation and advantageous effects of the present exemplary embodiment.

In the seatback 14 of the above configuration, the front member 50 that contacts the seated person, and the back member 58 arranged at the opposite side of the front member 50 to the seated person, are coupled together by the plural hook-and-loop fasteners 64. The first separation restriction section 66 and the second separation restriction section 72 are provided to the seatback 14. The first separation restriction section 66 is configured by the first engaging portion 68 provided to the front member 50 and the first engaged portion 70 provided to the back member 58. The second engaging portion 74 is provided with the second separation restriction section 72, and the second engaged portion 76 is provided to the back member 58.

In the first separation restriction section 66, separation of the front member 50 and the back member 58 is restricted by the first engaging portion 68 and the first engaged portion 70 engaging in the separation direction of the front member 50 and the back member 58 (in this case the front-rear direction). In the second separation restriction section 72, separation of the front member 50 and the back member 58 is restricted by the second engaging portion 74 and the second engaged portion 76 engaging in the separation direction of the front member 50 and the back member 58 (in this case the front-rear direction).

When separating the front member 50 and the back member 58, the coupling by the plural hook-and-loop fasteners 64 can be released by, for example, inserting a tool such as a spatula or the like between the front member 50 and the back member 58, and applying external force in the separation direction. The restriction from the first separation restriction section 66 and the second separation restriction section 72 as described above can then be released by displacing the front member 50 with respect to the back member 58 in a direction intersecting with the separation direction (in this case upward and downward). This thereby enables a task of separating the front member 50 and the back member 58 to be facilitated compared to hitherto.

Moreover, in the present exemplary embodiment, the first engaging portion 68 and the second engaging portion 74 are formed in hook shapes, and the first engaged portion 70 and the second engaged portion 76 include the insertion holes 70A, 76A into which the first engaging portion 68 and the second engaging portion 74 are inserted. This thereby enables the separation of the front member 50 and the back member 58 to be restricted by a simple configuration.

Moreover, the present exemplary embodiment includes the first separation restriction section 66 arranged at the one side in the orthogonal direction (in this case the upper side) orthogonal to the separation direction, and the second separation restriction section 72 arranged at the another side in the orthogonal direction (in this case the lower side). This thereby enables separation of the front member 50 and the back member 58 to be effectively restricted.

Moreover, in the present exemplary embodiment, the displacement direction of the front member 50 for releasing the restriction on separation by the first separation restriction section 66 is toward the another side in the orthogonal direction (in this case downward), and the displacement direction of the front member 50 for releasing the restriction on separation by the second separation restriction section 72 is toward the one side in the orthogonal direction (in this case upward). Due to the displacement direction of the front member 50 for releasing the restriction to separateing by the first separation restriction section 66 being set as the opposite direction to the displacement direction of the front member 50 for releasing the restriction to separateing by the second separation restriction section 72, the restriction of the front member 50 and the back member 58 from separation is accordingly not liable to be released unintentionally.

Moreover, in the present exemplary embodiment, the displacement direction of the front member 50 for releasing the restriction to separateing by the second separation restriction section 72 is set upward, and the restriction to separateing by the second separation restriction section 72 is accordingly maintained due to the front member 50 being urged downward by gravity. This accordingly means that the restriction to separateing by the second separation restriction section 72 is maintained even if, for example, coupling by the plural hook-and-loop fasteners 64 were to be released during a transportation vehicle collision or the like. Moreover, the length along the height direction of the upper extension portion 68B of the first engaging portion 68 is set longer than the length along the height direction of the lower extension portion 74B of the second engaging portion 74, and so the restriction to separateing by the first separation restriction section 66 is maintained unless the restriction to separateing by the second separation restriction section 72 has been released. This thereby enables separation of the front member 50 and the back member 58 to be effectively avoided.

Moreover, in the present exemplary embodiment, the front member 50 includes the front-side pan frame 52 formed in a plate shape, the pad 54 superimposed on the surface (in this case the front face) of the front-side pan frame 52, and the front-side covering 56 that covers the pad 54 from the opposite side to the front-side pan frame 52 and that has an outer edge portion anchored to the front-side pan frame 52. Due to adopting such a configuration, the front member 50 can be configured simply, and also the comfort of the seated person can be secured by the pad 54.

Moreover, in the present exemplary embodiment, the back member 58 includes the back-side pan frame 60 formed in a plate shape and the back-side covering 62 that covers the surface (in this case the rear face) of the back-side pan frame 60 and has an outer edge portion anchored to the back-side pan frame 60. Due to adopting such a configuration, the back member 58 can be configured simply, and also a good external appearance of the back member 58 is achieved by the back-side covering 62.

Note that although in the above exemplary embodiment a case has been described in which the seatback 14 is a transportation vehicle seat member according to the present disclosure, there is no limitation thereto, and the seat cushion 12 and the headrest 16 may also be employed as the transportation vehicle seat member according to the present disclosure.

Moreover, although in the above exemplary embodiment a case has been described in which the plural hook-and-loop fasteners 64 are coupling members, there is no limitation thereto, and the coupling member may, for example, be double sided adhesive tape.

In addition to the above, various modifications may be implemented to the present disclosure within a range not deseparation from the spirit of the present disclosure. Obviously the scope of rights of the present disclosure is not limited to the above exemplary embodiment.

What is claimed is:

1. A transportation vehicle seat member configuring part of a transportation vehicle seat, the transportation vehicle seat member comprising:
a front member configured to contact a seated person;
a back member arranged at an opposite side of the front member to the seated person;
a coupling member configured to couple the front member and the back member together and configured such that coupling is released by applying an external force in a separation direction to separate the front member from the back member; and
a separation restriction section that is configured by an engaging portion provided to one of the front member or the back member and an engaged portion provided to another of the front member or the back member, that is configured to restrict separation by engagement of the engaging portion and the engaged portion in the separation direction, and that is configured to release the restriction by the front member being displaced with respect to the back member in a direction intersecting with the separation direction.

2. The transportation vehicle seat member of claim 1, wherein:
the engaging portion is formed in a hook shape; and
the engaged portion includes an insertion hole for insertion of the engaging portion.

3. The transportation vehicle seat member of claim 2, further comprising:
a first separation restriction section, arranged at one side in an orthogonal direction orthogonal to the separation direction; and
a second separation restriction section arranged at another side in the orthogonal direction.

4. The transportation vehicle seat member of claim 3, wherein:
a displacement direction of the front member for releasing the restriction by the first separation restriction section is toward the another side in the orthogonal direction; and
a displacement direction of the front member for releasing the restriction by the second separation restriction section is toward the one side in the orthogonal direction.

5. The transportation vehicle seat member of claim 1, wherein the front member includes:
a front-side pan frame formed in a plate shape;
a pad superimposed on a surface of the front-side pan frame; and
a front-side covering that covers the pad from an opposite side to the front-side pan frame and that has an outer edge portion anchored to the front-side pan frame.

6. The transportation vehicle seat member of claim 1, wherein the back member includes:
a back-side pan frame formed in a plate shape; and
a back-side covering that covers a surface of the back-side pan frame and has an outer edge portion anchored to the back-side pan frame.

7. A transportation vehicle seat, comprising:
a seat cushion configured to support buttocks and thighs of a seated person;
a seatback configured to support a back of the seated person; and
a headrest configured to support a head of the seated person,
wherein at least one of the seat cushion, the seatback or the headrest comprises the transportation vehicle seat member of claim 1.
